(19) United States
(12) Patent Application Publication
(10) Pub. No.: US 2004/0095621 A1
(43) Pub. Date: May 20, 2004

(54) Process for production of optically diffractive structure, duplication plate material and medium

(76) Inventors: Hiroshi Funada, Tokyo (JP); Fumihiko Mizukami, Tokyo (JP); Nobuyuki Honna, Tokyo (JP)

Correspondence Address: WILDMAN, HARROLD, ALLEN & DIXON, 225 WEST WACKER DRIVE, CHICAGO, IL, 60606, US

(21) Appl. No.: 10/663,077

(22) Filed: Sep. 16, 2003

(30) Foreign Application Priority Data
Sep. 18, 2002 (JP) 2002-271174

(51) Int. Cl. G02B 5/18; G02B 5/32

(52) U.S. Cl. 359/1; 359/566; 264/1.31; 264/1.36

(57) ABSTRACT

The present invention provides a production process of, duplication plate material for duplication of, and medium provided with an optically diffractive structure such as a hologram and diffraction grating having excellent optically diffractive effect, wherein the optically diffractive structure has a surface configuration having plural corrugation-like convexo-concave shapes, and the convexo-concave shapes of the final medium is formed by using a duplication plate material. The convexo-concave shapes of the duplication plate material have a cross-sectional surface which is crosswise to the peaks of the convexo-concave shapes, and a salient section defined by a salient line and a middle line has a smaller area than that of an adjacent reentrant section defined by a reentrant line and the middle line. Herein, the middle line is drawn by connecting midpoints of the height of the convexo-concave shapes. The salient line is outline of the top of the convexo part, and the reentrant line is outline of the bottom of the concave part.

### BACKGROUND OF THE INVENTION

1. Field of the Invention

The present invention relates to a process for production of an optically diffractive structure. More specifically, it relates to a process for production of, a duplication plate material of, and a medium provided with an optically diffractive structure such as a hologram and a diffraction grating having excellent optically diffractive effect, wherein the surface is formed into a configuration having plural corrugation-like (ridge- and/or individually standing peak-like) convexo-concave shapes.

2. Description of the Related Art

Original plate photographing of hologram, diffraction grating and so on is highly technical in photographing technique where it is taken in vibration-free environment with special facilities and operation of dangerous laser. The original plate (photographic dry plate state) taken in this way is generally kept in safe as it is extremely difficult to produce the same in twice and highly precious. Moreover, it is said that only several companies in the world can industrially practice from production of the original plate to duplication using it. The surface of said original plate of a relief hologram and a diffraction grating consists of several hundred to several thousand super fine convexo-concave shapes per 1 mm in length. The said convexo-concave shapes consist of plural cycles of corrugation containing ridge-like peaks and/or individually standing peaks, where optically diffractive effect significantly degrades depending on the shape of said peak, therefore, it is necessary to duplicate the convexo-concave shapes accurately, precisely and exactly. Mass duplication (mass production) is extremely difficult as only an exactly duplicated convexo-concave shape can present enough optically diffractive effect.

The relief hologram and the diffraction grating are mass duplicated by the following steps. The 1^{st} (child) duplicating original plate (master plate) is made from the original plate, the 2^{nd} (grandchild) intermediate plate material is made, the 3^{rd} (great grandchild) intermediate plate material is made, and if necessary, the 4^{th}, 5^{th} . . . n^{th} (ancestor) intermediate plate material are made. It is possible to mass duplicate (mass produce) the relief hologram and the diffraction grating by mounting plural duplication plate materials (also called as a press plate and a plate material) made from the 2^{nd} to n^{th} (ancestor) intermediate plate material on a duplication device. The duplication plate material herein is an intermediate material used for mass duplication (production) by mounting on the duplication device. It is possible to obtain several dozen to several hundred of duplication plate materials from one intermediate plate material. Because the duplication plate material maybe the 3^{rd}, 4^{th} and even 10^{th} intermediate plate material depending on a lot produced, or the intermediate plate material may be used as duplication plate material if the lot is small, the intermediate plate material and the duplication plate material may be all together called, an intermediate plate material or simply a plate material.

Fine convexo-concave shapes are generally interference fringes made by interfering laser, and it has a sine wave shape. Therefore, the convexo-concave shapes remain unchanged by repeated duplication though the height (difference) between peaks and troughs becomes lower. The number of duplicated products that one duplication plate material can produce (mass duplicate) (i.e. print durability) is significantly small compared with a printing plate material of a general printing method. The said duplication plate material consumes a lot, therefore, the operation is repeated to produce the 1^{st} to n^{th} intermediate plate materials, and produce the duplication plate material from the th intermediate. However, the optically diffractive effect of a medium and a product duplicated by the duplication plate material was often not enough. The convexo-concave shapes were so fine that the cause thereof was not clear. To handle the situation the duplication plate material of excellent optically diffractive effect was selected and used for mass production on production site for a long time.

Conventionally, it is known that the duplication plate material used in production of the optically diffractive structure is made by vapor-depositing gold or the like on a surface of a photographed original plate, forming a nickel plating layer having a thickness of several hundred μm using the deposited layer as an electrode, and peeling the nickel plating layer. There are problems such as being unable to use the deposition layer of gold or the like as the electrode, and being difficult to peel the nickel plating duplication plate material. There are also inferiorities such as taking long time for nickel plating, having small quantity of capable plating, and being expensive.

Japanese patent laid-open publication Nos. Hei 1-238679 and Hei 3-29986 disclose a method to produce a resin-made multifaceted plate material by successively advancing the duplication process from a photographed original plate, through a nickel plated duplication original plate to obtain a glass-made duplication original plate material, and then successively repeating 2P method for plural times from the obtained glass-made duplication original plate material to produce the resin multifaceted plate. Also, Japanese patent publication Nos. Hei 6-85103, Hei 6-85104 and Hei 7-104600 disclose a method to mass duplicate resin-made duplication plate material by successively repeating 2P method for plural times from a photographed original plate to produce the resin-made duplication plate materials. However, no related art states or implies about influences imposed on the optically diffractive effect by the convexo-concave shapes of the duplicated surface.

Japanese patent laid-open publication No. Hei 6-270165 discloses a technique to adjust a size accuracy of a duplication plate material by controlling temperature and humidity. However, the known technique does not control fine convexo-concave shapes at surface itself by temperature and humidity, and there is neither mentioned about influences imposed on the optically diffractive effect by the convexo-concave shapes of the duplicated surface.

### SUMMARY OF THE INVENTION

In view of the above-mentioned problems, an object of the present invention is to provide a process for production of an optically diffractive structure and a medium having an optically diffractive structure such as a hologram and a diffraction grating of excellent optically diffractive effect by using a duplication plate material selectively having a surface configuration having plural corrugation-like (ridge- and/or individually standing peak-like) convexo-concave shapes.

In order to achieve the above object, according to a first aspect of the present invention, a process for production of an optically diffractive structure provided with a surface configuration having plural corrugation-like convexo-concave shapes, comprises steps of:

providing a duplication plate material provided with a surface configuration having plural corrugation-like convexo-concave shapes, and having a cross-sectional surface crosswise to said corrugation, in which a salient section which is defined by a salient line and a middle line which is drawn by connecting midpoints of the height of the convexo-concave shapes is smaller in area than that of an adjacent reentrant section which is defined by a reentrant line and the middle line and these salient and reentrant sections are situated next to each other on the bias having midpoints in common;

pressing an optically diffractive layer made of ionizing radiation curable resin with the duplication plate material under a heating or non-heating condition to impart a surface configuration having plural corrugation-like convexo-concave shapes to the optically diffractive layer; and

curing the optically diffractive layer with ionizing radiation after and/or upon providing said surface configuration.

When an advancing direction of the corrugation on the surface of the duplication plate material is curved in the process described above, it is preferable to draw the middle line crosswise to a tangent to an inflection of the corrugation.

The corrugation-like convexo-concave shapes of the duplication plate to be used may comprise individually standing peak-like shapes.

According to a second aspect of the present invention, a duplication plate material to be used in the process of the first aspect described above is provided. This duplication plate material has a good duplicating performance to accurately reproduce fine convexo-concave shapes of an optically diffractive structure such as a hologram and a diffraction grating.

According to a third aspect of the present invention, a medium having an optically diffractive structure produced by the process of the first aspect described above is provided.

In one embodiment of the medium described above, a surface of the optically diffractive layer may comprise a collection of plural sections different in corrugation direction and/or corrugation cycle and/or convexo-concave shape and/or convexo-concave height.

In another embodiment of the medium, the corrugation-like convexo-concave shapes may form a relief hologram and/or a diffraction grating.

The process described above has a good performance to impart a surface configuration, and therefore convexo-concave of an original plate is accurately reproduced, thus producing an optically diffractive structure such as a hologram and a diffraction grating having excellent optically diffractive effect.

Further, even when a surface configuration to be duplicated is complicated one such as a corrugation having a curved direction, an optical diffraction grating composed by layering convexo-concave with a diffraction direction different from each other, the surface configuration can be accurately formed in the process of the present invention, whereby producing an optically diffractive structure having excellent optically diffractive effect.

### BRIEF DESCRIPTION OF THE DRAWINGS

In the accompanying drawings:

FIG. 1 is an explanatory diagram of mass production where an intermediate plate material is repeatedly made from an original plate, and the intermediate plate material is used as a duplication plate material;

FIG. 2 is a schematic view explaining 2P method;

FIG. 3 is a cross-sectional view showing a duplication plate material used in the process for production of the present invention;

FIG. 4 is a cross-sectional view explaining convexo-concave shapes of the duplication plate material;

FIG. 5 is a cross-sectional view showing an emboss-duplicated optically diffractive structure by the duplication plate material in FIG. 4;

FIG. 6 is a schematic cross-sectional view showing a medium having an optically diffractive structure presented in the way of an example in the present invention; and

FIG. 7 is a graph showing luminance property of examples 1 to 3 and comparative examples 1 to 3 of the present invention.

### DETAILED DESCRIPTION OF THE PREFERRED EMBODIMENT

Hereinafter, with reference to figures, the embodiment of the present invention will be explained in detail.

Convexo-Concave Shapes at Surface:

Convexo-concave shapes at surface can be applied to a bright printing, an optically diffractive structure or the like having a corrugation-shape with peak cycle (repeating unit) generally from several hundred nm to 1 μm which creates special bright effect. It is especially applicable to an optically diffractive structure such as a relief hologram and a diffractive grating having from several hundred to several thousand of convexoconcave within 1 mm. Photographing of the hologram, the diffraction grating or the like is technical and requires advanced technique where interference fringes of laser are recorded by operating special and dangerous laser facility in vibration-free environment. An original plate (photographic dry plate state) taken in this way are generally kept in safe as it is extremely difficult to produce the same in twice and therefore highly precious.

Moreover, it is said that only several companies in the world can industrially practice from production of the original plate to duplication from the original plate. The surface of said photographed original plate of the relief hologram and the diffraction grating comprises from several hundred to several thousand super fine convexo-concave shapes. Said convexo-concave shapes are paralleled lines in which more than hundreds ridge-like shaped peaks are collecting per 1 mm range, and whereby the convexo-concave shapes, as a whole, forms a corrugation-like convexo-concave peaks. The convexo-concave depth (difference between the top and the bottom of the peak) is from about 0.01 to several μm. When the corrugation-like convexoconcave is the relief hologram, said convexoconcave may have fringe pattern like wind ripple made by interference fringe of a photographing object. On the other hand, when the corrugation-like convexoconcave is the diffraction grating, said diffractive grating does not have a wind ripple-like fringe pattern, but has just repeated plural peak-like convexo-concave shapes. The depth of said fringe pattern is from fraction of several number to one several hundredth of the depth of ridge-shaped convexoconcave, which is from about 0.01 to some μm. It is extremely difficult to accurately duplicate such super fine convexo-concave shapes by mass duplication (production).

Moreover, length of the ridge-like peaks of convexo-concave shapes at surface can be short or it may be individually standing peaks like a cone. The surface of convexo-concave shapes may be not uniform overall and may be comprised of a collection of plural sections different in peak direction (a direction of ridge-lines) and/or peak distance (peak cycle) and/or convexo-concave shape and/or convexo-concave height (difference in height) at surface.

Hologram:

A design of a hologram-image is not particularly limited if the image suits uses and purpose. For example, signs, letters, figures, illustrations and so on that present necessary meaning can be freely applied. The image of the hologram itself can be created by appropriate means such as holographic stereogram technique from 2-dimensional or 3-dimensional image data obtained by calculation of hologram diffraction grating or by a digital image imported from a digital camera or a computer graphics apart from photographing a real object. Images such as letters can be expressed by defining its outline or frame by arrangement of the diffraction grating.

Relief Hologram:

In one aspect of classification, a hologram includes a volume type and a relief type. In the present invention, a relief hologram and/or a diffraction grating reproducible of 2-dimensional or 3-dimensional image from its surface configuration formed into convexo-concave shapes (optically diffractive relief) are suitable. For the relief hologram, a hologram and a diffraction grating having light intensity distribution of interference fringe by light interference of objective light and reference light recorded with convexo-concave patterns can be applied. Examples of said relief holograms include: laser reproduction hologram such as Fresnel hologram, Fraunhofer hologram, lens-less Fourier transform hologram, and image hologram; white light reproducing hologram such as rainbow hologram; and relief holograms using those principles such as color hologram, computer hologram, hologram display, multiplex hologram, holographic stereogram, and holographic diffraction grating.

Diffractive Grating:

Apart from a holographic diffraction grating using hologram recording methods, there is a diffraction grating which can obtain a given diffraction light based on the calculation by drawing a diffraction grating mechanically using a precision lathe, an electron beam lithography device (electron beam drawing device) and so on. Such hologram and diffraction grating can be recorded singly or multiply and also in combination. When the diffraction grating is a collection comprising plural sections each of which is different in direction of ridge line of the peak and/or peak cycle (peak distance) and/or shapes of convexo-concave and/or convexo-concave height (difference of height between the top and the bottom of peak), i.e. a regular or random combination of plural sections different in diffraction direction, a peculiar photoluminescent of good design can be obtained.

In the case of single diffraction grating, the effect of the present invention is not so remarkable since plural peaks are lined regularly in parallel so that a disarrangement of convexo-concave shapes does not easily occur. For the diffractive structure having plural sections different in diffraction direction, diffraction wavelength, and diffraction angle, and having complicated convexo-concave shapes, the present invention is suitable and provides remarkable effects, since the convexo-concave shapes are accurately reproduced upon duplication.

Duplication Method:

To commercially duplicate fine convexo-concave shapes such as a hologram, first, several generations of intermediate plate materials are made from original plate (parent) in which convexo-concave shapes are formed, and an intermediate plate material of proper generation is selected from said intermediate plate materials as a duplication plate material (also called as a plate material or a stamper). In a method (hereinafter referred as a semi-dried duplication method) of the present invention, the optically diffractive layer made of ionizing radiation curable resin is pressed with a duplication plate material (so called an emboss treatment), and irradiated with ionizing radiation after convexo-concave shapes are formed (duplication, forming) to the surface of the optically diffractive layer, or at the same time as embossing, and then the duplication plate material (stamper) is peeled off to obtain a next generation of the duplication plate material. Also, it may be possible to apply Photo Polymerization method (hereinafter referred as 2P method) wherein a liquid ionizing radiation curable resin is applied to the duplication plate material and pressed and stretched thereon to form a surface configuration, then cured by irradiating with ionizing radiation to peel the used duplication plate material from the cured next generation of the duplication plate material.

The semi-dried method is capable of mass duplicating with low cost, and thus it is suitable for a commercial duplication process. In the semi-dried method, the substrate (support) of the duplication plate material (stamper) is preferably made from resin, and such a resin made substrate is wrapped around or stuck on a cylinder of a duplication device, and then a continuously long receptive medium is fed into the duplication device to consecutively stamp on the fed receptive medium with the duplication plate material.

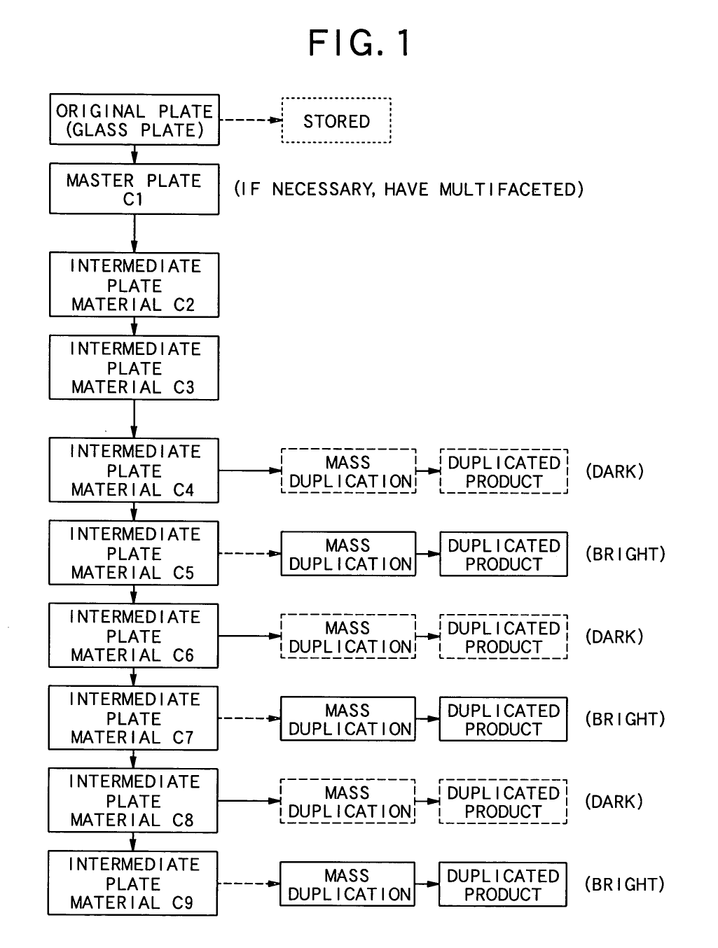

FIG. 1 is an explanatory diagram of mass duplication operation by repeatedly making intermediate plate materials from an original plate and using an intermediate plate material as a duplication plate material.

Intermediate Plate Material:

Prior to the commercial duplication, a duplication plate material (plate material or stamper) to be mounted on a duplication device is made from an original plate (parent). From the original plate (parent), the 1^{st} intermediate plate material (child) is made, and further the 2^{nd} intermediate plate material (grandchild), the 3^{rd} intermediate plate material (great grandchild), and the nth intermediate plate material are successively made in order to mass duplicate a relief hologram and a diffraction grating. The original plate (parent) is well preserved. For production of intermediate plate material 10, 2P method is generally used.

Making Multifaceted:

In a case of photographing hologram of large area, since it takes long photographing time (in photo shooting, it is called as shutter time), it is difficult to maintain a vibration-free condition for said time. Therefore, plural numbers of an original plates (parent), a master plates, or the 1^{st} to 3^{rd} intermediate plate materials 10 having small areas respectively are formed, and connected together in the horizontal direction to obtain one multifaceted original plate having large area. The n^{th} intermediate plate material 10 may be created from such a multifaceted original plate as required.

Duplication Plate Material:

A duplication plate material (plate material or stamper) to be mounted on a duplication device is properly selected from n^{th} intermediate materials depending on the number of products (duplication) per lot. For an actual duplication plate material mounted on the duplication device, generally the 1^{st} to 15^{th}, preferably the 3^{rd} to 9^{th}, and more preferably the 3^{th} to 7^{th} intermediate plate material is used.

Feature of the Invention:

Fine convexo-concave shapes to be formed by interference of laser are in a form of sine wave (sine curve). On the other hand, fine convexo-concave shapes to be formed by drawing with beams are in a form of square wave, and it is said that, as referred in the related arts, such a fine convexo-concave shapes in a form of square wave remain in a same form despite repeated duplications. However, commercial duplication, mainly embossing method, is a plastic working, in which convexo-concave shapes of a duplicated medium slightly degrade depending on applied methods and conditions, degradation of duplicated shapes is caused and carried over by every duplication step. It is assumed that the degradation is caused by incomplete forming (molding), shrinkage and elasticity recovery of ionizing radiation curable resin, environmental conditions, external stress or the like. The present invention is accomplished based on a discovery that: an original plate and an intermediate plate material are made so as to previously avoid causing degradation of convexo-concave shapes; the duplication plate material is selected from the obtained intermediate plate materials; and said duplication plate material is used for duplication, thereby producing a medium which exhibits an excellent effect of diffraction.

More specifically, when a middle line is drawn by connecting midpoints of convexo-concave height (difference in height between the top and the bottom of the peak) in a cross-sectional surface crosswise to the corrugation-like peaks, sections of the top of peak (a salient section) which is defined by a salient line of the cross-sectional surface and the middle line and the other sections (a reentrant section) of the pocket (valley) of peak which is defined by a reentrant line of the cross-sectional surface and the middle line are alternately lines along the middle line in a state of facing the middle line. In this assumption, the convexo-concave shapes of a duplicated medium as a final product is controlled so as that the salient section has a larger area than that of the adjacent reentrant section.

The medium whose surface is formed into desired convexo-concave shapes in this way can be observed brightly because the convexo-concave shapes corresponding to illumination light increase diffraction borrowed light.

On the other hand, the duplication plate material in the present invention has a surface configuration reverse to that of the final medium. That is, in a cross-sectional surface of the convexo-concave shapes of the duplication plate material, the salient section is smaller in area than that of the adjacent reentrant section.

The desired convexo-concave shape is not be limited, and may be of sine wave, rectangle wave, and blaze wave. The peak may be ridge-shaped or individually standing (cone-like shaped) peak.

For drawing the middle line, eleven consecutive adjacent convexoconcave in a cross-sectional surface are selected. Halfway from the bottom of concave and the top of convex of adjacent convexoconcave is decided as midpoints. In the same manner, 10 midpoints are decided and a line connecting the midpoints (the points indicating average values) is considered as a middle line. In the cases of having complicated convexo-concave shapes such as a hologram, having a diffraction grating where plural diffraction direction are crossing, and having hologram and/or diffraction grating with fine areas, two consecutively adjacent convexoconcave in a cross-sectional surface may be selected to calculate midpoints in the same manner as described above.

Duplication Plate Material and Mass Duplication:

Referring to FIG. 1 again, the intermediate plate material is generally made by 2P method from the original plate and an appropriate intermediate plate material is selected as duplication plate material from said intermediate plate material to produce medium. The production (mass duplication) concept thereof is explained hereunder. The master plate is made from the original plate (photographed or drawn glass plate) by 2P method. Single or multifaceted duplication plate material for mass duplication should be produced from the master plate. Therefore, said duplication plate material is selected from the intermediate plate materials C2 to Cn, which are obtained from the master plate by repeating the n^{th} duplication.

Actual production of the medium is proceeded by mounting the intermediate plate material Cn on the duplication device as a plate material. Conventionally, the convexo-concave shape on a surface of the intermediate plate material Cn was not considered. The duplication plate material was just selected accordingly according to the number of production. However, in the present invention, brightness and quality of the duplicated medium can be improved by selecting the convexo-concave shape of the duplication plate material. Further, when the original plate is produced by photographing or drawing with beams, it is preferable to control so as that an area drawn by a salient line and the middle line is larger than an area drawn by a reentrant line and the middle line. Here, the salient line and the reentrant line mean positions when the original plate is viewed from the side of an observer.

Convexo-Concave Shape of Duplication Plate Material:

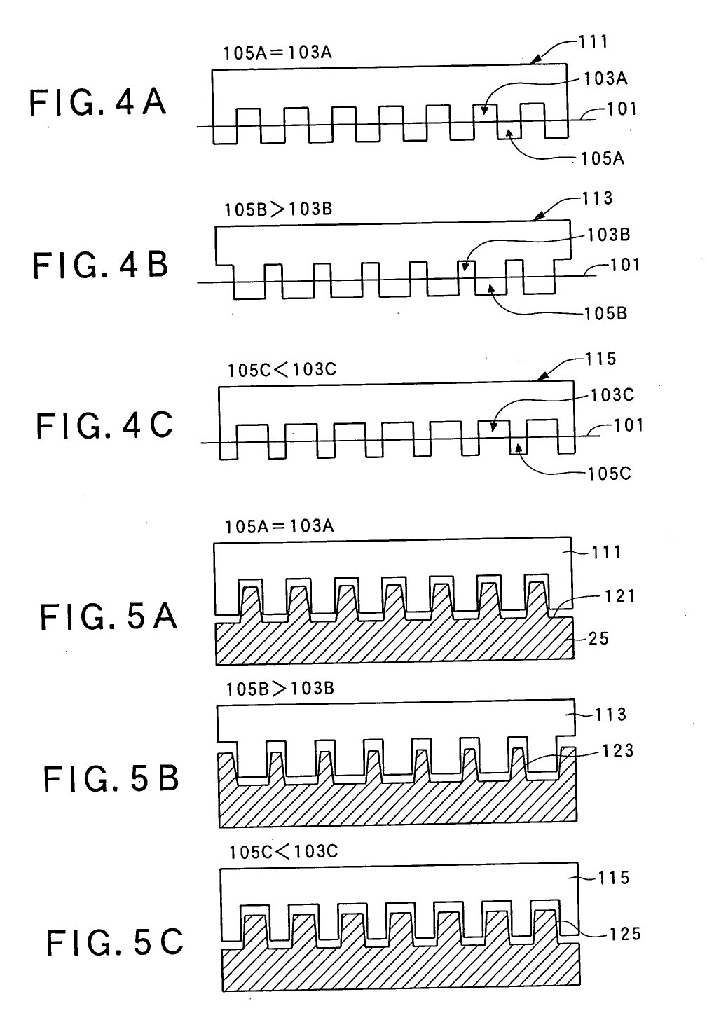

FIG. 4 is a cross-sectional view explaining convexo-concave shapes of a duplication plate material.

When convexo-concave shapes of a diffraction grating original plate having peaks in straight ridge-line are interference fringe formed by laser, the convexo-concave shapes are generally in a form of a sine wave. In a cross section of this sine wave, an area drawn by a salient line and a middle line is same as an area drawn by a reentrant line and the middle line. When the diffraction grating original plate is produced by drawing with beams, ideally the convexo-concave shape will be in a form of a rectangle wave. FIG. 4 is showing a frame format of the rectangle-shaped convexo-concave shapes for assisting understanding of the operation.

In FIG. 4(A), the duplication plate material (even convex and concave) 111 has the area 105A defined by the salient line and the middle line as same as the area 103A defined by the reentrant line and the middle line. In FIG. 4(B), the duplication plate material (large convex) 113 has the area 105B defined by the salient line and the middle line larger than the area 103B defined by the reentrant line and the middle line. In FIG. 4(C), the duplication plate material (small convex) 115 has the area 105C defined by the salient line and the middle line smaller than the area 103C defined by the reentrant line and the middle line.

Each can be observed that the duplication plate material (even convex and concave) 111 in FIG. 4(A) is best in diffraction efficiency and the brightest, next is the duplication plate material (large convex) 113 in FIG. 4(B), and the duplication plate material (small convex) 115 in FIG. 4(C) follows.

However, surprisingly the duplication plate material used in the process of the present invention is the duplication plate material (small convex) 115 and not the duplication plate material (even convex and concave) 111, which is the brightest.

Optically Diffractive Structure of Medium:

FIG. 5 is a cross-sectional view of an optically diffractive structure emboss-duplicated by the duplication plate material of FIG. 4.

The convexo-concave shapes of an optically diffractive structure each of which is mass duplicated by emboss method using, as a duplication plate material, a duplication plate material (even convex and concave) 111, a duplication plate material (large convex) 113, or a duplication plate material (small convex) 115 will be described hereunder. The optically diffractive structure is processed to a medium, or unified by known means such as sticking, affixing, adhering, transferring or the like, and the medium finally produced is used. Therefore, it is preferable that the optically diffractive structure of the final medium is controlled so as to have desired convexo-concave shapes exhibiting the good efficiency and brightness of diffraction. A frame format of rectangle-shaped convexo-concave shapes is shown in FIG. 5 so that the operation is easy to understand, however, actual convexo-concave shapes are not limited to rectangle.

FIG. 5 shows the mass duplication by subjecting an optically diffractive lay 25 to the emboss method using the duplication plate materials of FIG. 4, wherein the materials are slightly separated for easy understanding.

FIG. 5(A) shows an example of using the duplication plate material (even convex and concave) 111 to subject the optically diffractive layer 25 to the emboss method. Even when the optically diffractive layer 25 is heated for the emboss method, it does not melt nor does become liquid state, and it is pressed in solid or softened state on the course of the emboss process. Therefore, in the case as shown in FIG. 5(A), the optically diffractive layer 25 can not completely fit in the concave part of the duplication plate material (even convex and concave) 111, and convex parts of the final medium thus formed are small and has a sharpened top in comparison with the corresponding concave parts of the duplication plate. On the other hand, the convex parts of the duplication plate material (even convex and concave) 111 can relatively easily get into the optically diffractive layer 25 to form concave parts of the final medium. As the result, the convexo-concave shape of the optically diffractive structure (small convex) 121 has small convex parts.

FIG. 5(B) shows an example of using the duplication plate material (larger convex) 113 to subject the optically diffractive layer 25 to the emboss method. Similarly to the case of FIG. 5(A) described above, convex parts of the final medium are formed into a further small size and a further sharpened top in accordance with further narrow concave parts of the duplication plate. On the other hand, since the convex parts of the duplication plate material 113 are large in area and disperses emboss pressure, it is difficult to get into the optically diffractive layer 25, whereby forming shallow concave parts on the final medium. As the result, the convexo-concave shape of the formed optically diffractive structure (smallest convex) 123 has significantly small convex parts.

FIG. 5(C) shows an example of using the duplication plate material (small convex) 115 to subject the optically diffractive layer 25 to the emboss method. As shown in FIG. 5(C), since the optically diffractive structure (small convex) 115 has wide concave parts, the optically diffractive layer 25 easily fits in the concave part of the duplication plate material (small convex) 115, and convex parts of the final medium thus formed have relatively accurate shape. On the other hand, since the convex parts of the duplication plate material 115 are small and sharpen state, it is easy to get into the optically diffractive layer 25, whereby forming accurate concave parts on the final medium. As the result, the convexo-concave shapes of the formed optically diffractive structure (even convex and concave) 125 on the final medium are most accurately reproduced in the desired convexo-concave shapes.

2P Method:

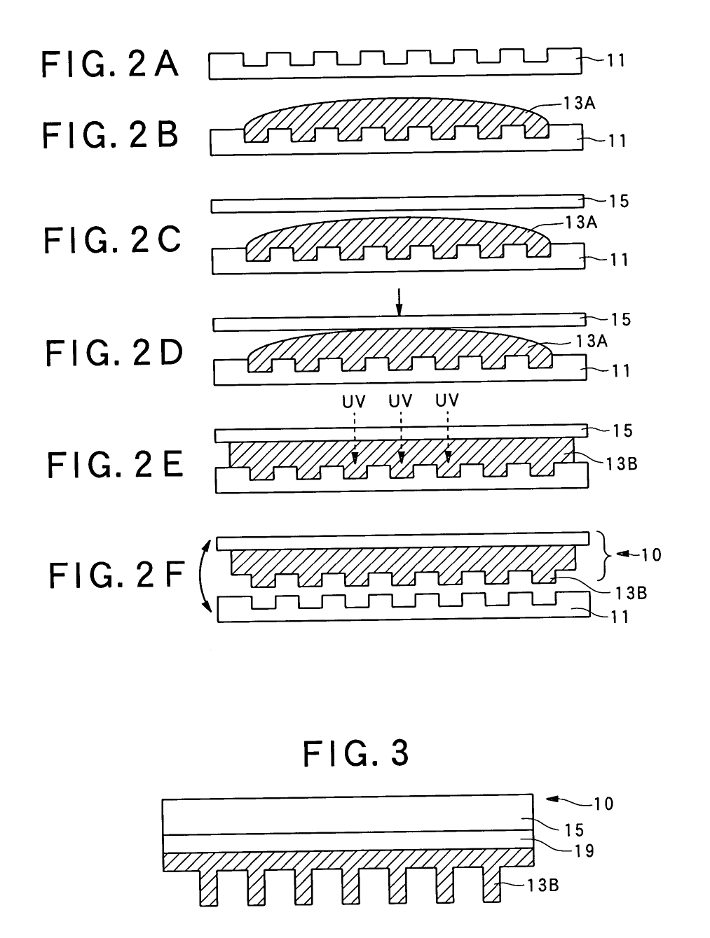

FIG. 2 shows schematic view explaining the 2P method. The intermediate plate material (including the duplication plate material) may be made by Photo Polymerization method (2P method) comprising the steps of applying an ionizing radiation curable resin to an original plate, curing the applied resin by irradiation with ionizing radiation, and peeling the cured resin. The 2P method is generally known as an effective method for forming convexo-concave shape on a substrate and used for duplication of known optical parts or another articles.

A process of 2P method is briefly shown in FIG. 2. FIG. 2(A) shows an original plate in which a relief having convexo-concave shape is formed. As shown in FIG. 2(B), an ionizing radiation curable resin 13A is dropped onto the original plate, and then, as shown in FIGS. 2(C) and 2(D), a duplication substrate 15 is layered thereon and pressed down. Next, in the state as shown in FIG. 2(E), ionizing radiation such as ultraviolet is radiated to the applied resin from the side of an original plate 11 or the duplication substrate 15 to cure the ionizing radiation curable resin 13A. Finally, as shown in FIG. 2(F), a lamination in which the cured resin 13B is unified with the substrate 15 is peeled off from the original plate 11 to obtain the master plate. Further, an intermediate plate material C2 is made from the master plate by the 2P method. Furthermore, an intermediate plate material C3 is made from the intermediate plate material C2 by the 2P method. Still furthermore, an intermediate plate material C4 is made from the intermediate plate material C3 by the 2P method.

The relief having the convexo-concave shape shown in FIG. 2 is in a form of rectangle wave for easy explanation, however, it is not limited to rectangle-form. A cross section of the convexo-concave shape of the relief can take various forms such as wave-shape, serrate (blazed)-shape and so on apart from the above described rectangle wave depending on the process for production of the original plate. If hologram image is recorded thereon, more convexoconcave is present on the convexo-concave relief.

FIG. 3 is a cross-sectional view showing a duplication plate material used in the process for production of the present invention.

The intermediate plate material (including duplication plate material) exemplified by FIG. 3 is composed of the substrate 15, a primer layer 19, an ionizing radiation-cured resin layer 13B, where they are layered successively. A surface configuration thereof has a corrugation-like convexo-concave shapes containing plural ridge- and/or individually standing peak-like convexo-concave shapes. In a cross sectional surface along a direction crosswise to the corrugation-like convexo-concave shapes, a middle line is drawn by connecting midpoints of the convexo-concave height (difference in height between the top and the bottom of the convexo-concave shapes), and a salient section is defined by a salient line of the convex part and a middle line, and further an adjacent reentrant section is defined by a reentrant line of the concave part and the middle line. These salient and reentrant sections are situated next to each other on the bias having midpoints in common. In this assumption, the salient sections and the reentrant sections are alternately lined along the middle line in a state that these salient and reentrant sections is facing the middle line, and the each salient section is smaller in area than that of the adjacent reentrant section. In extremely plain words, the convex part in the duplication plate is small and sharp in comparison with the adjacent concave parts.

Forming Method of Duplication Plate Material (Small Convex):

There are several applicable methods to obtain the duplication plate material having such a convexo-concave shape, and the method is not particularly limited. To make an original plate by photolithographic method, repeating times of 2P method required for producing a duplication plate material to be used in a duplication device is calculated backward, and based on a calculated result, the convexo-concave shape of the original plate is decided whether making concave part wide and convex part narrow or vice versa.

In a method to photograph an interference fringe by using laser beams, the exposure condition may be reviewed to slightly over exposure or double exposure, or to thickly coat a photosensitive material for the purpose of controlling the convexo-concave shape of the original plate. In the 2P method, the convexo-concave shape of the original plate may be controlled by adjusting the viscosity or surface tension of ionizing radiation curable resin component 13A in a procured state, or pressure against the original plate, or timing of pressing and irradiating ionizing radiation. Also in the 2P method, the convexo-concave shape is successively degraded corresponding to repeating times. Since degree of degradation deferrers between a duplicated product out of odd times of repeating the 2P method and that of even times of repeating the 2P method, it is preferred to use a duplication plate material out of odd times of repeating the 2P method and out of small number of n^{th} duplicating generation.

Substrate of Duplication Plate Material:

As a substrate 15 of the intermediate plate material (including the duplication plate material), there may be used, for example, metal plate, glass plate, plastic sheet or the like. When the duplication plate material is stuck around a cylindrically shaped plate drum of a duplication device, the plastic sheet is suitable as the substrate.

Examples of plastic sheet include polyester resins such as polyethylene terephthalate, polybuthylene terephthalate, polyethylene naphthalate, polyethylene terephthalate-isophthalate copolymer, terephthalic acid-cyclohexanedimethanol-ethylene glycol copolymer, and coextruded film of polyethylene terephthalate/polyethylene naphthalate; polyamide resins such as niron 6, niron 66, and niron 610; polyolefin resins such as polymethylpentene; vinyl resins such as polyvinylchroride; acryl resins such as polyacrylate, polymethacrylate, and polymethylmethacrylate; imides resins; engineering resins such as polyarylate, polysulfone, polyether sulfone, polyphenylene ether, polyphenylene sulfide (PPS), polyalamid, polyether ketone, polyether nitrile, polyether ether ketone, and polyether sulfide; polycarbonate; styrene resins such as ABS resin; and cellulose films such as cellophane, cellulosetriacetate, cellulosediacetate, and nitrocellose.

The films maybe made of copolymer resin or mixture (including polymer alloy) containing said resins as main component or it may be multi-layered lamination. The film may be oriented film or unoriented film, but uniaxial direction or biaxial direction oriented film is preferred to improve the film strength. The thickness of said film is generally about 25 to 1000 μm, but about 50 to 200 μm is preferable. In general, polyester film such as polyethylene terephthalate and polyethylene naphthalate is preferably used from the viewpoint of good heat resistance, size stability and ionizing radiation resistance or the like, and polyethylene naphthalate is more preferable.

Prior to applying an ionizing radiation curable resin on the substrate film, the surface thereof may be subject to an adhesion-facilitating treatment such as a corona discharge treatment, a plasma treatment, an ozonation, a flame treatment, a primer coating treatment (a primer is also called as an anchor coat, an adhesion promoter and an adhesion-enhancing agent), a preheating treatment, a dust removal treatment, a vapor-deposition treatment, an alkali treatment. If necessary, an additive such as a filler, a plasticizer, a coloring agent and an antistatic agent may be added to said film.

Ionizing Radiation Curable Resin Layer:

An ionizing radiation-cured resin layer 13B on which the convexo-concave shapes of an original plate are formed is converted from an ionizing radiation curable resin layer 13A by irradiation with ionizing radiation. Though the ionizing radiation may be classified by quantum theoretical energy levels thereof, the ionizing radiation to be used in the present invention means includes at least all the ultraviolet radiations (UV-A, UV-B, UV-C), visible lights, y-rays, X-rays and electron beams. Among them, ultraviolet rays (UV) and electron beams are preferable. The ionizing radiation curable resin layer 13A (precursor resin layer) curable by ionizing radiation may be added photo polymerization initiator and/or photo polymerization promoter thereto. When the layer is cured with electron beams having high energy, addition of the photo polymerization initiator and/or promoter is not necessary. If the ionizing radiation curable resin layer 13A contains an adequate catalyst, it may be cured by heat energy.

The ionizing radiation-cured resin layer 13B is formed by curing the ionizing radiation curable resin layer 13A by irradiating ionizing radiation. The ionizing radiation curable resin layer 13A may contain a curable component which has at least one functional group capable of causing polymerization (or curable) reaction by ionizing radiation. As said curable component, there may be used a compound which has radical polymerizable unsaturated double bond such as mono-functional monomer, multi-functional monomer of more than 2 function, functional oligomer and functional polymer. The functional group capable of polymerizing (or curing) with ionizing radiation may be acryloyl group, methacryloyl group, allyl group, and epoxy group.

Examples of mono-functional monomer include (meth)acrylic acid or ester thereof (e.g. alkyl ester, aryl ester) such as acrylic acid, methyl acrylate, ethyl acrylate, buthyl acrylate, 2-ethylhexyl acrylate, isobuthyl acrylate, methylmethacrylate, 2-ethylhexylmethacrylate, 2-hydroxyethylacrylate, 2-hydroxypropylacrylate, nonylphenol EO-adduct acrylate (DNPA), 2-hydroxy-3-phenoxypropylacrylate (HPPA), 3-ethyl-3-hydroxymethyloxetane; aryl ester; styrene; methylstyrene; styrene acrylonitrile; and n-vinylpyrrolidon.

It is to be noted that (meth)acrylic acid in the present specification means as acrylic acid and/or methacrylic acid. Also, (meth)acrylate means as acrylate and/or methacrylate. Similar descriptions are considered in the same manner.

Examples of di-functional monomer include 1,6-hexanediolacrylate (HDDA), hexyamethylenediacrylate, diethylene glycoldiacrylate (DEGDA), neopentylglycoldiacrylate (NPGDA), tripropylene glycoldiacrylate (TPGDA), polyethylene glycol 400 diacrylate (PEG400DA), hydroxypivalic acid ester neopentylglycoldiacrylate (HPNDA), and bisphenol A EO-modified diacrylate, 1,4-bis[(3-ethyl-3-oxetanylmethoxy)methyl]benzene.

Examples of the multi-functional monomer maybe (meth) acryloyl monomer with bi- or more functional obtained by reacting bi- or more functional compounds such as ethylene glycol, glycerin, pentaerythritol, epoxy resin or the like with (meth) acrylic acid or derivative thereof. Concrete examples thereof include: trimethylolpropaneacrylate (TMPTA), pentaerythritoltriacrylate (PETA), dipentaerythritolhexaacrylate (PEHA), dipentaerythritolpentaacrylate, trimethylolpropane EO-modified triacrylate, and dimethylolpropanetetraacrylate.

As the functional oligomer (or called as prepolymer), there may be used an oligomer with weight average molecular weight in a range from about 300 to about 5000, and having, in its molecule, radical polymerizable unsaturated double bond such as (meth) acryl group, (meth)acryloyl group, allyl group, or another radical polymerizable group such as epoxy group. Examples of the functional oligomers include polyurethanes, polyesters, polyethers, polycarbonates, poly(meth) acrylates or the like, and more concrete Examples include urethane (meth) acrylate, isocyanulate(meth)acrylate, polyester(meth)acrylate, polyester-urethane(meth)acrylate, epoxy(meth)acrylate, amino-modified triacrylate, and fatty acid acrylate.

As the functional polymer, there may be used a polymer with weight average molecular weight in a range from about 1000 to about 300 thousands, and having, in its molecule, radical polymerizable unsaturated double bond such as (meth) acryl group, (meth) acryloyl group, allyl group, or another radical polymerizable group such as epoxy group. Examples of the functional polymer include urethane(meth)acrylate, isocyanulate(meth)acrylate, polyester-urethane(meth)acrylate, and epoxy(meth)acrylate.

The above described curable monomer and/or oligomer and/or polymer can be contained in the ionizing radiation curable resin composition. To provide ionizing radiation curable property to the resin composition, these curable components are contained at usually 5% by weight or more, preferably 10 to 90% by weight, and more preferably 20 to 80% by weight based on an amount of the ionizing radiation curable resin composition (precursor).

The ionizing radiation curable resin composition may contain at least one kind of monomers, and may further contain another monomer called as reactive diluent. Said monomer is mono-functional reactive diluent having an group such as (meth)acryl group, (meth)acryloyl group, allyl group, and epoxy group. The reactive diluent used herein is different from general organic solvents, e.g. toluene, and means that it does not contain any solvent such as general organic solvent, e.g. toluene. Generally, the ionizing radiation curable resin composition has a high viscosity, and it cannot be used for a coating process unless its viscosity is adjusted to low range by organic solvent.

When the monomer functioning as reactive diluent is incorporated into the ionizing radiation curable resin (precursor), the viscosity of the resin composition lowers so that there is no need of solvent and non-solvent type ionizing radiation curable resin composition can be used. Also oligomer has the same effect.

Monomer and oligomer improve speed (rate) of polymerization reaction. Oligomer and polymer can adjust cross-linking density, cohesion strength and so on of the ionizing radiation curable resin layer 13B after curing. For these reasons, it is preferred to use monomer and/or oligomer and/or polymer in the ionizing radiation curable resin (precursor). More preferably, the above mentioned monomer, oligomer and polymer may be used in combination at a proper compounding ratio to make the property of the ionizing radiation curable resin layer 13B suitable for uses and purposes. Additives such as polymerization inhibitor, antioxidant and so on may be added to the ionizing radiation curable resin (precursor) as required. To the ionizing radiation curable resin layer 13B, if necessary, additive such as plasticizer, lubricating agent, coloring agent such as dye and pigment, filler such as extender and resin for extension and preventing blocking, surfactant, defoamer, leveling agent, and thixotropy promoter may be added.

In the electron beam irradiation, the electron beam generated by electron beam accelerator is used for irradiation. The electron beam irradiation device maybe, for instance, Cockroft Walton type, Van de Graf type, resonance transformer type, insulating core transformer type, or an electron beam accelerator such as linear type, Dynamitron type, and high frequency type, and irradiation with an electron beam is carried out by an electron curtain system and a beam scanning system or the like. It is preferable to use “Electro curtain” (trade name), which is a device to radiate uniform electronbeam in a form of curtain-like shape from a linear filament.

The irradiation dose of electron beam is generally 0.5 to 20 Mrad using electrons having energy of generally 100 to 1000 keV, and preferably 100 to 300 keV. If the dose is less than 0.5 Mrad, unreacted monomer may remain in a cured resin layer to cause insufficiency of curing. Also, if the dose is over 20 Mrad, cross-linking density becomes excessively high so that the cured binder or a substrate may be damaged. The atmosphere of curing process is generally set to 500 ppm or less of oxygen density, and preferably about 200 ppm.

Photo Polymerization Initiator:

Upon ultraviolet irradiation, photo polymerization initiator, for example, acetophenones, benzophenones, Michler-benzoylbenzoate, α-amiloxime ester, tetramethylthiuram monosulfide, thioxanthones, and if necessary, photosensitizer such as n-butylamine, triethylamine, and tri-n-butylphosphine may be added to the ionizing radiation curable resin composition.

For the ultraviolet curing process, ultraviolet lamp (the UV lamp) such as a high-pressure mercury lamp or a metal-halide lamp may be used, a wavelength of the ultraviolet is in a range from 200 to 400 nm, and proper wavelength may be selected in accordance with natures of the ionizing radiation-curable resin composition. The irradiation dose of the ultraviolet ray may be determined in consideration of natures or an amount of the ionizing radiation-curable resin, output of the UV lamp, processing speed or the like.

Mass Duplication Method:

The mass duplication method applicable to the present invention may be the 2P method, the embossing method or the semi-dried duplication method, and the semi-dried duplication method is suitable. When the semi-dried duplication method is applied to the present invention, the processes are advanced as follows: a duplication plate material (plate or stamper) of the present invention is wrapped around or stuck on a cylindrical plating dram (cylinder or emboss roller); said duplication plate material is pressed (so called emboss) to an optically diffractive layer 25 made of an ionizing radiation curable resin composition to form (mold, duplicate) a surface of the optically diffractive layer 25 into convexo-concave shapes; the optically diffractive layer 25 is peeled off from the duplication plate material and then irradiated with ionizing radiation, or the optically diffractive layer 25 is irradiated with ionizing radiation at the same time as embossing and then peeled off from the duplication plate material. In the semi-dried method, a resin-made substrate can be used as a substrate of the duplication plate material and the duplication plate material using the resin-made substrate can be wrapped around or stuck on a cylindrical plating dram, and thereby it makes it possible to conduct a consecutive operation of duplication work with the use of along optically diffractive layer 25 made of an ionizing radiation curable resin composition. Therefore, the semi-dried method is suitable for a commercial duplication method, and it attains mass production with low cost.

Medium:

A medium having an optically diffractive structure of the present invention is produced by a process comprising steps of:

providing a duplication plate material provided with a surface configuration having plural corrugation-like convexo-concave shapes, and having a cross-sectional surface crosswise to said corrugation, in which a salient section which is defined by a salient line and a middle line which is drawn by connecting midpoints of the height of the convexo-concave shapes is smaller in area than that of an adjacent reentrant section which is defined by a reentrant line and the middle line and these salient and reentrant sections are situated next to each other on the bias having midpoints in common;

pressing an optically diffractive layer made of ionizing radiation curable resin with the duplication plate material under a heating or non-heating condition to impart a surface configuration having plural corrugation-like convexo-concave shapes to the optically diffractive layer; and

curing the optically diffractive layer with ionizing radiation after and/or upon providing said surface configuration.

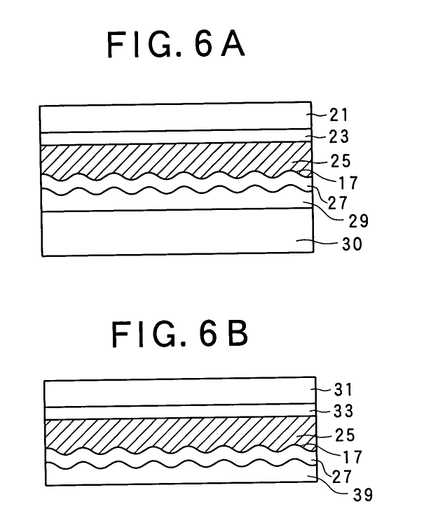

FIG. 6 is a cross-sectional view showing the medium having the optically diffractive structure as one example of the present invention.

The convexo-concave shapes formed in the process for production of the present invention accurately reproduce desired convexo-concave shapes, have the optically diffractive structure of good luminance characteristics, have bright and good design, and are usable to various embodiments. In general, the medium of the present invention can be used as labels as shown in FIG. 6(A) and transfer ribbons (transfer foils) as shown in FIG. 6(B), however, it may be applied to other embodiments.

Label-Form:

FIG. 6(A) shows one example of labels, which has a layered structure composed of label substrate 21, if necessary primer layer 23, optically diffractive layer (having optically diffractive structure at surface thereof) 25, reflection layer 27, adhesive layer 29, and if necessary peeling paper 30. As a material of each layer, conventionally known materials may be used. The medium in a form of label can be used as follows: the adhesive layer 29 of the medium is exposed by peeling off the peeling paper, and then the medium is stuck or affixed on various things.

Transfer Ribbon Form:

FIG. 6(B) shows one example of transfer ribbons, which has a layered structure composed of transfer substrate 31, peelable layer 33, optically diffractive layer (having optically diffractive structure at surface thereof) 25, reflection layer 27, and adhesive layer 39. As a material of each layer, conventionally known materials may be used. The medium in a form of transfer ribbon may be used for transfer processes in such manner that the medium is pressed onto various transfer receiving materials under the heating condition by means of conventionally known hot stamping-transfer device, thermal printer or the like.

Effect of the Invention:

According to the process for production of the optically diffractive structure of the present invention, even when a medium is duplicated by the commercial duplication method such as the embossing method, the duplicated medium can exhibit superior diffraction effect. When a duplication plate of the present invention is wrapped around a cylindrical plating dram, it is possible to mass duplicate the diffractive structure which has bright and stable diffraction borrowed light and takes a serial roll-to-roll form.

When the duplication plate material of the present invention is used, it is possible to mass duplicate the diffractive structure which has bright and stable diffraction borrowed light by the commercial duplication method such as the embossing method.

The medium of the present invention is a final product having an optically diffractive structure which is formed so as to have desired convexo-concave shapes, and the diffraction borrowed light which is provided by illumination corresponding the desired formed convexo-concave shapes is increased, thus making it possible to observe the medium brighter. The desired convexo-concave shape is not particularly limited, and it may be sine wave, rectangle wave, blaze wave or the like. The peaks may be ridge-like shape or individually standing peaks.

### EXAMPLES

### Example 1

### Preparation of Transfer Ribbon

As a transfer substrate 31, a polyester film (trade name: Lumirror F53, available from Toray Industries, Inc.) having thickness of 6 μm was used. A coating liquid for the peelable layer composition was prepared by dissolving 98 parts by weight of ultraviolet curable resin (trade name: SUZ600, available from Inctec Inc.) and 2 parts by weight of polyester resin (trade name: VYLON 29SS, available from Toyobo Co., Ltd.) in a solvent so as to dilute at 15% by weight in solid content. The prepared coating liquid was applied onto one surface of the transfer substrate by the gravure coating method, and dried to form a peelable layer 33 having thickness of 0.5 μm in dried state.

A coating liquid was prepared by dissolving the ultraviolet curable resin (trade name: SUZ600, available from Inctec Inc.) in a solvent so as to dilute at 17% by weight in solid content. The prepared coating liquid was applied onto the peelable layer 33 by the gravure coating method, and dried to form an optically diffractive layer 25 having thickness of 0.5 μm in dried state, thereby preparing an intermediate product of medium (intermediate medium).

On the other hand, an original plate having master diffraction grating was prepared by drawn with the electron beam. Duplication according to the 2P method was started from the original plate, and successively repeated for five times to obtain an intermediate plate material C5 as fifth generation. The intermediate plate material C5 thus obtained was used as a duplication plate material C5 (stamper), and it was affixed and wrapped around an emboss roller of the duplication device.

A surface of the optically diffractive layer 25 of the intermediate medium was heat-pressed (embossed) between the emboss roller having the duplication plate material (stamper) and a counter roller heated at about 150° C. to form the optically diffractive structure 17 having a fine convexo-concave pattern.

Regarding the duplication plate material C5 (stamper), the area defined by the salient line and the middle line/the area defined by the reentrant line and the middle line=0.9/1.1. The original plate was preliminary drawn so as to have said result.

Right after forming the optically diffractive structure, the optically diffractive layer 25 was irradiated with ultraviolet wavelength of 300 to 400 nm by means of a high-pressure mercury lamp to be cured. Aluminum was deposited to the surface of said optically diffractive structure 17 by the vacuum deposition method to form reflection layer 27 having thickness of 400 nm. A coating liquid in which polyvinyl chloride acetate copolymer is dissolved and diluted by a solvent to be 25% by weight, was applied to the entire surface of the reflection layer 27 by the gravure printing method and dried so that the thickness was 2 μm in dried state. As the result, the adhesive layer 39 was formed and the transfer ribbon (medium having optically diffractive structure) was obtained.

### Comparative Example 1

The transfer ribbon was obtained in the same manner as in Example 1 except that an intermediate plate material C4 was prepared by successively repeating the duplication according to the 2P method for four times, and the intermediate plate material C4 thus prepared was used as a duplication plate material C4 (stamper).

### Example 2

The transfer ribbon was obtained in the same manner as in Example 1 except that an intermediate plate material C7 was prepared by successively repeating the duplication according to the 2P method for seven times, and the intermediate plate material C7 thus prepared was used as a duplication plate material C7 (stamper).

### Comparative Example 2

The transfer ribbon was obtained in the same manner as in Example 1 except that an intermediate plate material C6 was prepared by successively repeating the duplication according to the 2P method for six times, and the intermediate plate material C6 thus prepared was used as a duplication plate material C6 (stamper).

### Example 3

The transfer ribbon was obtained in the same manner as in Example 1 except that an intermediate plate material C9 was prepared by successively repeating the duplication according to the 2P method for nine times, and the intermediate plate material C9 thus prepared was used as a duplication plate material C9 (stamper).

### Comparative Example 3

The transfer ribbon was obtained in the same manner as in Example 1 except that an intermediate plate material C8 was prepared by successively repeating the duplication according to the 2P method for eight times, and the intermediate plate material C8 thus prepared was used as a duplication plate material C8 (stamper).

### Example 4

### Transparent Holographic Label

As a label substrate 31, a polyester film (trade name: Lumirror T60, available from Toray Industries, Inc.) having thickness of 50 μm was used. Urethane resin dissolved in a solvent so as to be diluted at 10% by weight in solid content was applied onto one surface of the label substrate 31 by the roll coating method and dried to form a primer layer 23 having thickness of 1 μm in dried state.

Ultraviolet curable resin (trade name: Yupimer LZ065, available from Mitsubishi Chemical Corporation) was dissolved in a solvent so as to be diluted at 25% by weight in solid content was applied onto a surface of the primer layer 23 by the reverse roll coating method and dried to form an optically diffractive layer 25 having thickness of 3 μm in dried state, thereby preparing an intermediate product of medium (intermediate medium).

On the other hand, a master hologram (original plate) was prepared by being drawn with the electron beam. Duplication according to the 2P method was started from the original plate, and successively repeated for five times to obtain an intermediate plate material CS as fifth generation. The intermediate plate material CS thus obtained was used as a duplication plate material CS (stamper), and it was affixed and wrapped around an emboss roller of the duplication device.

A surface of the optically diffractive layer 25 of the intermediate medium was heat-pressed (embossed) between the emboss roller having the duplication plate material (stamper) and a counter roller heated at about 150° C. to form the optically diffractive structure 17 having a fine convexo-concave pattern.

Regarding the duplication plate material C5 (stamper), the area defined by the salient line and the middle line/the area defined by the reentrant line and the middle line=0.95/1.05. The original plate was preliminary photographed so as to have said result.

Right after forming the optically diffractive structure, the optically diffractive layer 25 was irradiated with ultraviolet wavelength of 300 to 400 nm by means of a high-pressure mercury lamp to be cured. Zinc sulfide was deposited to the surface of the optically diffractive structure 17 by the vacuum deposition method to form reflection layer 27 having thickness of 400 nm.

An adhesive agent (Trade name: Nissetsu PE-118+CK101 available from Nippon Carbide Industries Co., Inc.) was applied onto a surface of the reflection layer 27 by the roll coating method at an applied amount of 25 g/m² in dried state and dried at 100° C. to volatilize the solvent. On a surface of the adhesive layer thus formed, a silicone-treated PET film (Trade name: SPO5, available from Tohcello Co., Ltd.) was laminated as peelable paper, and then a surface of the medium was impressed with half depth slit so as to make slit only in medium and not in peelable paper, thereby producing an adhesive label (medium having optically diffractive structure) of example 4.

### Example 5

### Transfer Ribbon

The transfer ribbon was obtained in the same manner as in Example 1 except that duplication according to the 2P method was started from the original plate which has master diffraction grating drawn with the electron beam, and successively repeated for five times to obtain an intermediate plate material C5 as fifth generation, that the intermediate plate material C5 thus obtained was used as a duplication plate material C5 (stamper), and that the area defined by the salient line and the middle line/the area defined by the reentrant line and the middle line was 0.8/1.2. The original plate was preliminary drawn so as to have the ratio mentioned above.

The original plate made by drawing method (photographic method) is especially preferable as it is possible to freely decide the ratio of the area defined by the salient line and the middle line/the area defined by the reentrant line and the middle line.

Evaluation:

The diffraction efficiency (luminance characteristics) was measured for evaluation. The measuring method was as follows. First, a xenon lamp was used as the light source, distance between light source and evaluation sample was set to 250 mm, incident angle of the light source to sample was set to 30°, and illuminance above the sample was set to 22000 lux. Then, luminance measuring device Topcon MB-7 (trade name, available from Topcon Corporation) was set to measure incident light within 1° of solid angle of the incident light at every one spot of the measuring device, the distance between the sample and the measuring device was set to 600 mm, and range of the measuring angle was set within 0 to −20°. Finally, luminance was measured in each measuring angel.

When diffraction efficiency of the transfer ribbon of Examples 1 to 3 and Comparative examples 1 to 3 was measured by illuminating monochromatic light from the transfer substrate side, the result shown in Table 1 was obtained. Regarding odd or even number of times of duplication, the result shows that the smaller the n^{th} becomes, the brightness is higher. Examples (odd n^{th} duplication plate material) had higher luminance compared with Comparative examples (even n^{th} duplication plate material where n^{th} is one smaller than said odd nth). The brightness was recognized even by visual observation.

TABLE 1

| Output | Comparative | Example | Comparative | Example | Comparative | Example |
|---|---|---|---|---|---|---|
| angle | Example 1 | 1 | Example 2 | 2 | Example 3 | 3 |
| −31 | 0.165 | 0.157 | 0.176 | 0.169 | 0.191 | 0.224 |
| −29 | 0.110 | 0.108 | 0.112 | 0.111 | 0.126 | 0.124 |
| −27 | 0.081 | 0.081 | 0.080 | 0.082 | 0.089 | 0.086 |
| −25 | 0.062 | 0.062 | 0.062 | 0.063 | 0.065 | 0.066 |
| −23 | 0.049 | 0.048 | 0.048 | 0.049 | 0.050 | 0.052 |
| −21 | 0.039 | 0.039 | 0.038 | 0.039 | 0.039 | 0.040 |
| −19 | 0.033 | 0.033 | 0.032 | 0.033 | 0.033 | 0.033 |
| −17 | 0.029 | 0.028 | 0.028 | 0.028 | 0.028 | 0.028 |
| −15 | 0.027 | 0.026 | 0.026 | 0.025 | 0.025 | 0.026 |
| −13 | 0.032 | 0.032 | 0.028 | 0.030 | 0.025 | 0.029 |
| −11 | 0.065 | 0.068 | 0.048 | 0.055 | 0.036 | 0.046 |
| −9 | 0.140 | 0.146 | 0.098 | 0.113 | 0.063 | 0.078 |
| −7 | 0.198 | 0.203 | 0.148 | 0.164 | 0.085 | 0.101 |
| −5 | 0.168 | 0.166 | 0.138 | 0.143 | 0.079 | 0.090 |
| −3 | 0.086 | 0.088 | 0.083 | 0.076 | 0.053 | 0.056 |
| −1 | 0.032 | 0.035 | 0.040 | 0.030 | 0.030 | 0.030 |
| 1 | 0.015 | 0.016 | 0.017 | 0.015 | 0.018 | 0.019 |
| 3 | 0.010 | 0.011 | 0.010 | 0.012 | 0.011 | 0.013 |
| 5 | 0.009 | 0.009 | 0.008 | 0.012 | 0.009 | 0.012 |
| 7 | 0.009 | 0.009 | 0.008 | 0.011 | 0.008 | 0.011 |
| 9 | 0.008 | 0.008 | 0.007 | 0.009 | 0.007 | 0.010 |
| 11 | 0.007 | 0.007 | 0.006 | 0.008 | 0.007 | 0.009 |

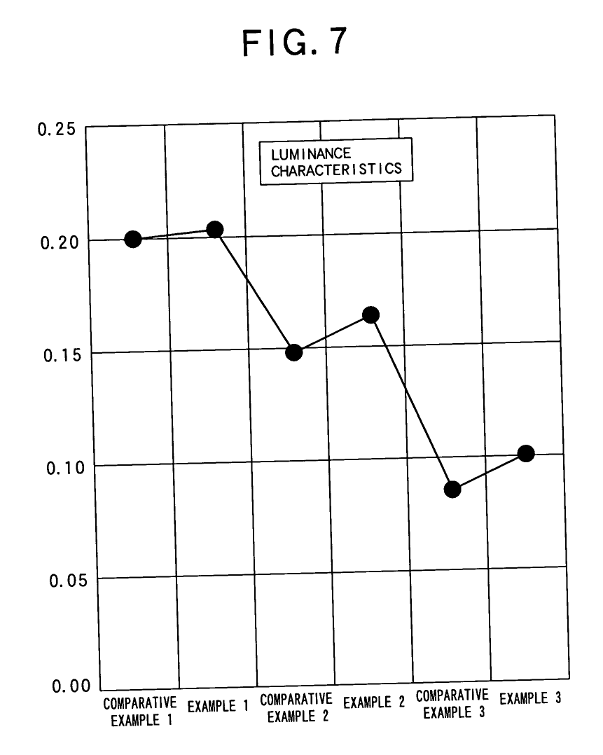

FIG. 7 is a graph showing luminance characteristics of Examples 1 to 3 and Comparative examples 1 to 3 in the present invention.

More specifically, FIG. 7 is a graph showing luminance of output angle −7° in Table 1. The examples using the duplication plate material having the area defined by the salient line and the middle line is smaller than the area defined by the reentrant line and the middle line exhibit better luminance characteristics. The reason why the luminance characteristics is downward-sloping as a whole is assumed that the influence of decrease in absolute value of convexo-concave height due to the resin shrinkage in the 2P-duplication process.

Therefore, as the duplication plate material of the present invention, it is preferable to choose an intermediate plate material with small duplication n^{th} and/or odd duplicated number. When the original plate is prepared by photographing or drawing, it is preferable to control the condition of photographing or drawing so as that the area defined by the salient line and the middle line is larger than the area defined by the reentrant line and the middle line. Herein, the salient line draws the top of the convex part, and the reentrant line draws the bottom of the concave part, when the convex-concave surface is viewed from the observer side.

Moreover, a bright transparent hologram label was obtained in Example 4. Example 5 was the transfer ribbon having metal reflection type diffraction grating, and thus it was especially bright and glittering in visual observation. Using the transparent hologram label of Example 4 or the diffraction grating transfer ribbon of Example 5, it is possible to laminate or transfer bright optically diffractive structure to various goods.

What is claimed is:

1. A process for production of an optically diffractive structure provided with a surface configuration having plural corrugation-like convexo-concave shapes, comprising steps of:
providing a duplication plate material provided with a surface configuration having plural corrugation-like convexo-concave shapes, and having a cross-sectional surface crosswise to said corrugation, in which a salient section which is defined by a salient line and a middle line which is drawn by connecting midpoints of the height of the convexo-concave shapes is smaller in area than that of an adjacent reentrant section which is defined by a reentrant line and the middle line and these salient and reentrant sections are situated next to each other on the bias having midpoints in common;
pressing an optically diffractive layer made of ionizing radiation curable resin with the duplication plate material under a heating or non-heating condition to impart a surface configuration having plural corrugation-like convexo-concave shapes to the optically diffractive layer; and
curing the optically diffractive layer with ionizing radiation after and/or upon providing said surface configuration.

2. A process for production of an optically diffractive structure according to claim 1, wherein the middle line is drawn crosswise to a tangent to an inflection of the corrugation when the corrugation is curved.

3. A process for production of an optically diffractive structure according to claim 1, wherein the corrugation-like convexo-concave shapes comprise individually standing peak-like shapes.

4. A duplication plate material for duplicating an optically diffractive structure provided with a surface configuration having plural corrugation-like convexo-concave shapes, wherein, the duplication plate material has plural corrugation-like convexo-concave shapes, and has a cross-sectional surface crosswise to said corrugation, in which a salient section which is defined by a salient line and a middle line which is drawn by connecting midpoints of the height of the convexo-concave shapes is smaller in area than that of an adjacent reentrant section which is defined by a reentrant line and the middle line and these salient and reentrant sections are situated next to each other on the bias having midpoints in common.

5. A medium having an optically diffractive structure produced by a process comprising steps of:
providing a duplication plate material provided with a surface configuration having plural corrugation-like convexo-concave shapes, and having a cross-sectional surface crosswise to said corrugation, in which a salient section which is defined by a salient line and a middle line which is drawn by connecting midpoints of the height of the convexo-concave shapes is smaller in area than that of an adjacent reentrant section which is defined by a reentrant line and the middle line and these salient and reentrant sections are situated next to each other on the bias having midpoints in common;
pressing an optically diffractive layer made of ionizing radiation curable resin with the duplication plate material under a heating or non-heating condition to impart a surface configuration having plural corrugation-like convexo-concave shapes to the optically diffractive layer; and
curing the optically diffractive layer with ionizing radiation after and/or upon providing said surface configuration.

6. A medium having an optically diffractive structure according to claim 5, wherein a surface of the optically diffractive layer comprises a collection of plural sections different in corrugation direction and/or corrugation cycle and/or convexo-concave shape and/or convexo-concave height.

7. A medium having an optically diffractive structure according to claim 5, wherein the corrugation-like convexo-concave shapes form a relief hologram and/or a diffraction grating.
